(19) United States
(12) Patent Application Publication
(10) Pub. No.: US 2009/0267434 A1
(43) Pub. Date: Oct. 29, 2009

(54) VIBRATION MOTOR

(76) Inventor: Young Il PARK, Gunpo-si (KR)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/431,711

(22) Filed: Apr. 28, 2009

(30) Foreign Application Priority Data
Apr. 28, 2008 (KR) 10-2008-0039394
Apr. 29, 2008 (KR) 10-2008-0039987
Jun. 30, 2008 (KR) 10-2008-0062499
Nov. 6, 2008 (KR) 10-2008-0109809
Nov. 6, 2008 (KR) 10-2008-0109811
Nov. 12, 2008 (KR) 10-2008-0112225

(51) Int. Cl. H02K 7/075

(52) U.S. Cl. 310/81

(57) ABSTRACT

Provided is a vibration motor. The vibration motor includes a housing, a support shaft, a rotor. First and second stators, and a power supply. The housing includes a bracket and a case coupled to the bracket. The support shaft is supported and fixed to the housing. The rotor is rotatably disposed on the support shaft. The first stator is disposed in the bracket, and the second stator is disposed in the case. The power supply supplies a power to the rotor to rotate the rotor.

### CROSS-REFERENCE TO RELATED APPLICATIONS

This application claims the benefit under 35 U.S.C. §119 of Korean Patent Application Nos. 10-2008-0039394, filed Apr. 28, 2008, 10-2008-0039987, filed on Apr. 29, 2008, 0-2008-0062499, filed on Jun. 30, 2008, 10-2008-0109811, filed on Nov. 6, 2008, 10-2008-0109809, filed on Nov. 6, 2008, and 10-2008-0112225. filed on Nov. 12, 2008, which are hereby incorporated by reference in their entirety.

### BACKGROUND

The present disclosure relates to a vibration motor.

In a vibration motor, an eccentric rotor including a coil is rotatably disposed inside a housing and a stator including a magnet is installed facing the rotor. When a current is applied to the coil, the rotor is rotated by interaction between the coil and the magnet to generate vibration.

Electronic products such as mobile communication devices include a built-in vibration motor that converts an incoming signal or an input signal into mechanical vibration.

For example, when a user presses a touch screen of the mobile communication device, the vibration is generated in the mobile communication device, allowing the user to recognize that the input signal has been correctly input in the mobile communication device.

Therefore, the time taken from the application of a driving signal to when a vibration motor generates normal vibration (the rising time) needs to be reduced.

### BRIEF SUMMARY

Embodiments provide a vibration motor having a novel structure. Embodiments also provide a vibration motor that can quickly generate normal vibration after a driving signal is applied.

In one embodiment, a vibration motor includes: a housing including a bracket and a case coupled to the bracket; a support shaft supported and fixed to the housing; a rotor rotatably disposed on the support shaft; a first stator in the bracket and a second stator in the case; and a power supply supplying a power to the rotor to rotate the rotor.

The details of one or more embodiments are set forth in the accompanying drawings and the description below. Other features will be apparent from the description and drawings, and from the claims.

### BRIEF DESCRIPTION OF THE DRAWINGS

FIG. 1 is a cross-sectional view of a vibration motor according to an embodiment.

FIG. 2 is a view illustrating a rotor of a vibration motor according to a first embodiment.

FIGS. 3 and 4 are views of a vibration motor according to a second embodiment.

FIGS. 5 and 6 are views of a vibration motor according to a third embodiment.

FIGS. 7 and 8 are views of a vibration motor according to a fourth embodiment.

FIGS. 9 and 10 are views of a vibration motor according to a fifth embodiment.

FIGS. 11, 12 and 13 are views of a vibration motor according to a sixth embodiment.

FIGS. 14 to 16 are views of a vibration motor according to a seventh embodiment.

### DETAILED DESCRIPTION

Hereinafter, a spindle motor according to embodiments will be described in detail with reference to the accompanying drawings.

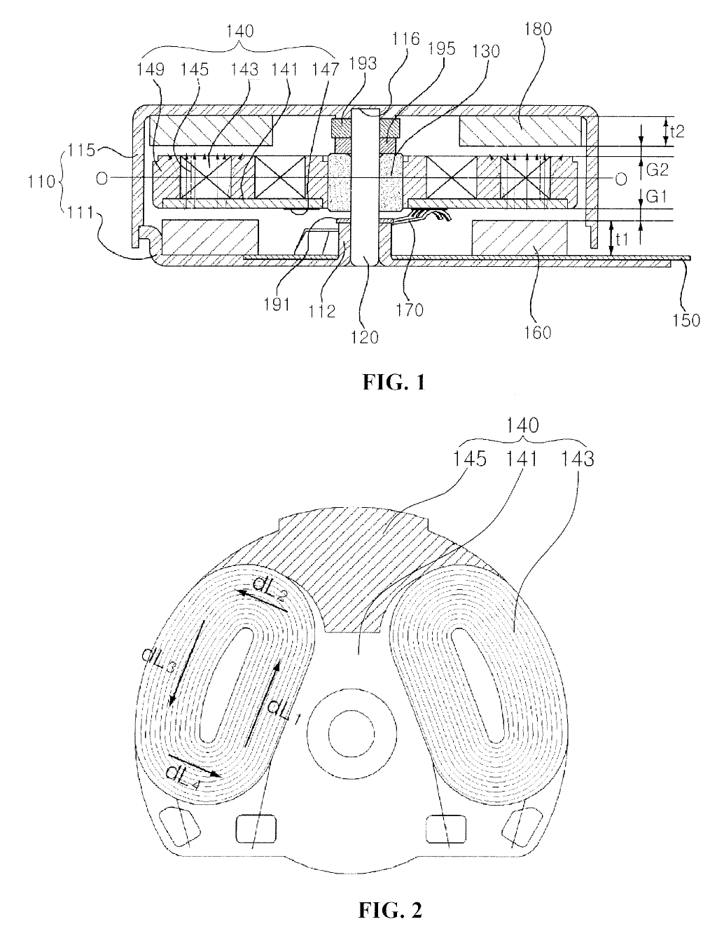

FIG. 1 is a cross-sectional view of a vibration motor according to a first embodiment, and FIG. 2 is a view illustrating a rotor of the vibration motor according to the first embodiment.

Referring to FIGS. 1 and 2, a housing 110 including a bracket 111 and a case 115 is disposed. The case 115 is disposed on and coupled to the bracket 111.

The case 115 and the bracket 111 may be formed of the same material or materials different from each other. For example, the case 115 may be formed of a metallic material, and the bracket 111 may be formed of a plastic material similar to that of a printed circuit board (PCB).

In this embodiment, all of the case 115 and the bracket 111 are formed of the metallic material. Also, when the bracket 111 is formed of the material similar to that of the PCB, a circuit board 150 that will be described later may not be installed.

A support shaft 120 is disposed inside the housing 110.

The support shaft 120 is coupled and supported to a support tube 112 protruding from the bracket 111 and a groove 116 defined in the case 115. That is, a lower end of the support shaft 120 is inserted into the support tube 112, and an upper end of the support shaft 120 is inserted into the groove 116.

When the bracket 111 is formed of the plastic material, a groove may be defined in the bracket 11 and a support tube may be disposed on the case 115.

A bearing 130 is rotatably disposed on the support shaft 120. An eccentric rotor 140 that integrally rotates together with the bearing 130 to generate vibration is coupled to the bearing 130. For example, an oil impregnated metal bearing may be used as the bearing 130.

A first washer 191 is disposed between the bearing 130 and the bracket 111 to reduce a friction force between the bearing 130 and the bracket 111. A second washer 193 is disposed between the bearing 130 and the case 115 to reduce a friction force between the bearing 130 and the case 115.

A third washer 195 is disposed between the second washer 193 and the bearing 130 to reduce a friction force between the second washer 193 and the bearing 130.

The friction force of the bearing 130 is minimized by the third washer 195 to generate normal vibration quicker than a vibration motor.

The third washer 195 has an external diameter less than that of the bearing 130 to reduce a friction area between the third washer 195 and the bearing 130.

For example, the first, second, and third washers 191, 193, and 195 may be formed of a resin material to improve anti-abrasion property and minimize the friction force.

A circuit board 150 surrounding the support shaft 120 is fixed to the bracket 111. Also, a first magnet 160 surrounding the support shaft 120 and having a ring shape is disposed on the bracket 111. The first magnet 160 functions as a first stator.

The rotor 140 rotating by interacting with the first magnet 160 is coupled to the bearing 130.

The rotor 140 includes a rotor board 141, a coil 143, a weight 145, and a support member 149.

The rotor board 141 includes a commutator 147 disposed on a bottom surface thereof, and the coil 143 electrically connected to the rotor board 141 is disposed on a top surface of the rotor board 141.

The rotor board 141 has an approximately semicircular plate shape to surround the bearing 130. A through hole is defined in a central portion of the rotor board 141.

A brush 170 is disposed on the circuit board 150. The brush 170 elastically contacts with the commutator 147 of the rotor board 141. The brush 170 electrically connects the circuit board 150 to the rotor board 141.

The circuit board 150 and the brush 170 function as a power supply for supplying a power to the rotor 140.

The coil 143 is fixed to the rotor board 141. In this embodiment, two coils 143 are disposed on both sides with respect to a center of the weight 145.

The weight 145 is supported to the rotor board 141. The rotor 140 is eccentric by the weight 145 to generate a vibration force.

The support member 149 is formed of a plastic material to integrally couple the rotor board 141, the coil 143, and the weight 145 to each other using an injection molding method. The support member 149 is coupled to an outer surface of the bearing 130.

Thus, the power supplied through the circuit board 150 is supplied to the coil 143 through the brush 170 and the rotor board 141 including the commutator 147. When the power is supplied to the coil, the rotor 140 rotates by an interaction between the rotor 140 and the first magnet 160.

A magnetic flux generated in the first magnet 160 passes through the coil 143 to flow into the case 115 functioning as a back yoke. Then, the magnetic flux flows again into the first magnet 160 to form a magnetic loop.

A magnetic flux generated on an outer surface and in inner surface of the first magnet 160 is weak. Thus, the magnetic flux does not flow in a direction perpendicularly passing through the rotor board 141, but flows in a radius direction of the support shaft 120 perpendicular to an axis-direction of the support shaft 120. Then, the magnetic flux flows into the outer and inner surfaces of the first magnet 160.

Thus, an electromagnetic force acts in the axis-direction of the support shaft 120 at circumference and central portions of the rotor 140 by the magnetic flux generated in the first magnet 160 to flow in the radius direction of the support shaft 120 and flow into the outer and inner surfaces of the first magnet 160.

Therefore, the rotor 140 rotates while the rotor 140 moves up and down like a seesaw with respect to the support shaft 120. As a result, upper and lower portions of the bearing 130 may be compressed by the support shaft 120 to allow oil to leak from the bearing 130.

A magnetic flux density B is given by: B=B_{ρ}a_{ρ}+B_{φ}a_{φ}+B_{z}a_{z}.

As shown in FIG. 2, according to a direction of a charge flow in the coil 143, a charge density is given by: DL₁=DL_{ρ1}a_{ρ}, DL2=DL_{φ2}a_{φ}, DL3=DL_{ρ3}a_{ρ}, and DL4=DL_{φ4}a_{φ}, and an electromagnetic force is given by: F=−d∫B×dL. Sine dL=dL₁+dL₂+dL₃+dL₄, the electromagnetic force F is given by: F=−I[∫B×dL₁+∫B×dL₂+∫B×dL₃+∫B×dL₄]. Here when only a z-direction component of components of the magnetic flux density B exists, the electromagnetic force F is given by: F=−I[∫BdL_{ρ1}a_{φ}−∫BdL_{ρ2}a_{ρ2}+∫BdL_{ρ3}a_{φ}−∫BdL_{ρ4}a_{ρ}]. Thus, an a_{z}-direction component of the electromagnetic force F is removed in the equation.

That is, since an electromagnetic force in a direction parallel to the axis-direction of the support shaft 120 does not exist, a force in which the rotor 140 moves up and down like a seesaw with respect to the support shaft 120 is removed.

In the vibration motor according to the first embodiment, a second magnet 180 functioning as a second stator is disposed to allow the magnetic flux generated in the first magnet 160 to increasingly pass through the coil 143 in the direction parallel to the axis-direction of the support shaft 120, i.e., a direction of arrows indicated in FIG. 1.

The second magnet 180 has a ring shape and is disposed inside the case 115. The second magnet 180 faces the first magnet 160.

Thus, the most magnetic flux generated in the first magnet 160 is not curved in the radius direction of the support shaft 120, but flows into the second magnet 180. Then, the magnetic flux flows again into the first magnet 160 to form a magnetic loop.

According to the above-described experiment, when the second magnet 180 is not installed, but only the first magnet 160 is installed, the electromagnetic force acting on the rotor 140 in the axis-direction of the support shaft 120 is about 1.1 g_{f}. On the other hand, when the first magnet 160 and the second magnet 180 are installed according to this embodiment, the electromagnetic force acting on the rotor 140 in the axis-direction of the support shaft 120 ranges from about 0.15 g_{f} to about 0.3 g_{f}.

Thus, in the vibration motor according to the first embodiment, the rotor 140 has a little effect on a force by which the rotor 140 moves up and down like a seesaw.

The second magnet 180 may have an internal diameter less than or equal to that of the first magnet 160. The second magnet 180 may have an external diameter greater than or equal to that of the first magnet 160. In this case, the magnetic flux generated on the outer and inner surfaces of the first magnet 160 may further effectively flow into the second magnet 180.

A gap G1 between the first magnet 160 and the rotor 140 and a gap G2 between the second magnet 180 and the rotor 140 may have a ratio of from about 1:0.2 to about 1:1. A thickness t1 of the first magnet 160 and a thickness t2 of the second magnet 180 may have a ratio of from about 1:0.3 to about 1:1. That is, a magnetic amount of a lower side with respect to a thickness center line O-O of the coil 143 in the axis-direction of the support shaft 120 may be greater than or equal to that of an upper side.

The vibration motor according to the first embodiment includes the first magnet 160 and the second magnet 180. That is, the vibration motor may use two magnets to increase the magnetic flux. Thus, since a rotation force is significantly applied to the rotor 140, a rising time of the vibration motor may be reduced.

Although the rotor 140 includes the coil 143, and the first and second magnets 160 and 180 are provided as the stators in the first embodiment, but it is not limited thereto. For example, the rotor 140 may include the magnets, and the coil may be provided as the stator.

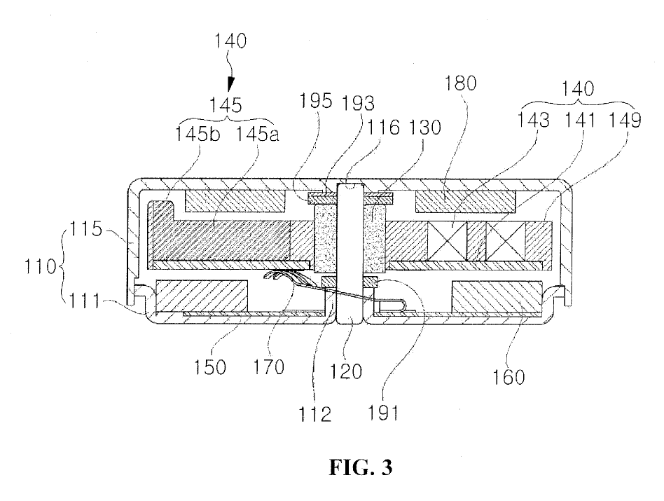

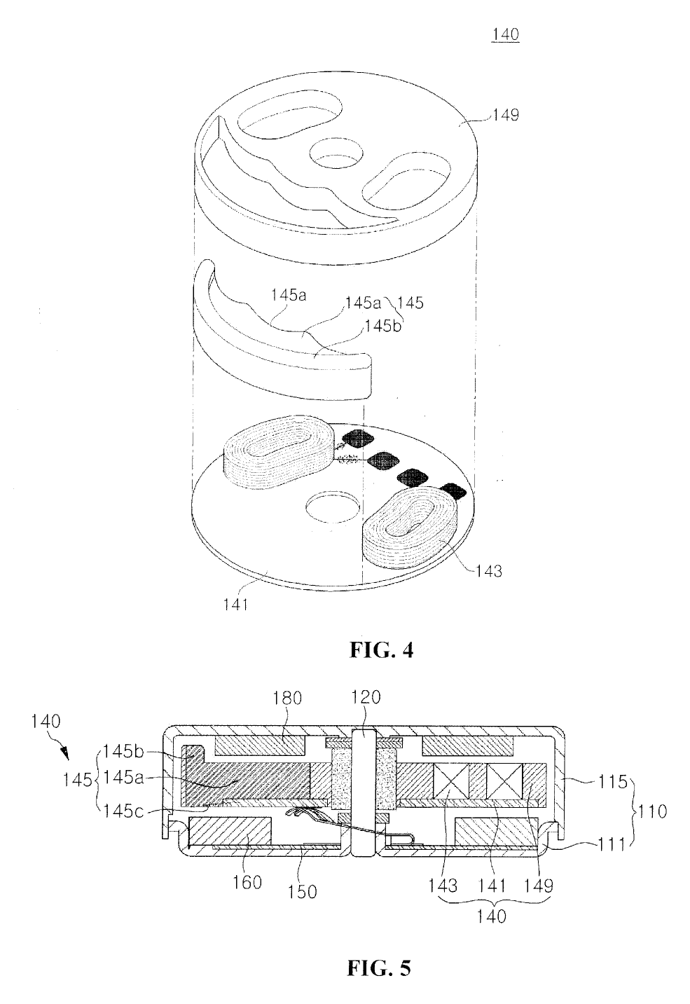

FIGS. 3 and 4 are views of a vibration motor according to a second embodiment.

In explanations of a vibration motor according to a second embodiment, explanations duplicated with the first embodiment will be omitted.

Referring to FIGS. 3 and 4, a housing 110 including a bracket 11 and a case 115 is disposed. A support shaft 120 is disposed inside the housing 110.

The support shaft 120 is coupled and supported to a support tube 112 protruding from the bracket 111 and a groove 116 defined in the case 115.

A bearing 130 is rotatably disposed on the support shaft 120. An eccentric rotor 140 that integrally rotates together with the bearing 130 to generate vibration is coupled to the bearing 130.

A first washer 191 is disposed between the bearing 130 and the bracket 111 to reduce a friction force between the bearing 130 and the bracket 111. A second washer 193 is disposed between the bearing 130 and the case 115 to reduce a friction force between the bearing 130 and the case 115.

A third washer 195 is disposed between the second washer 193 and the bearing 130 to reduce a friction force between the second washer 193 and the bearing 130.

A circuit board 150 surrounding the support shaft 120 is fixed to the bracket 111. Also, a first magnet 160 surrounding the support shaft 120 and having a ring shape is disposed on the bracket 111.

A second magnet 180 is disposed inside the case 115.

The rotor 140 is coupled to the bearing 130.

The rotor 140 includes a rotor board 141, a coil 143, a weight 145, and a support member 149.

The rotor board 141 includes a commutator 147 disposed on a bottom surface thereof, and the coil 143 electrically connected to the rotor board 141 is disposed on a top surface of the rotor board 141.

The rotor board 141 has an approximately semicircular plate shape to surround the bearing 130. A through hole is defined in a central portion of the rotor board 141.

A brush 170 is disposed on the circuit board 150. The brush 170 elastically contacts with the commutator 147 of the rotor board 141. The brush 170 electrically connects the circuit board 150 to the rotor board 141.

The coil 143 is fixed to the rotor board 141.

The weight 145 is supported to the rotor board 141. The rotor 140 is eccentric by the weight 145 to generate a vibration force.

The weight 145 includes a body part 145a and a first protrusion part 145b protruding upwardly from the body part 145a. The first protrusion part 145b is disposed at an external portion of the body part 145a spaced farthest from the support shaft 120. At least a portion of the first protrusion part 145b may protrude until at least a portion of the first protrusion part 145b is flush with the second magnet 180.

Thus, since the first protrusion part 145b is included, the weight 145 increases in weight. In addition, since the center of gravity of the weight 145 is spaced further away from that of the rotor 140, the vibration motor may have a greater vibration force, and a rising time may be reduced.

A lateral surface of the weight 145 may be curved to form a curved surface. Due to the curved surface, the weight 145 may be further strongly coupled to the support member 149.

Since the weight 145 and the coil 143 are disposed on the rotor board 141 in the second embodiment, a bottom surface of the weight 145 is flush with that of the coil 143.

The support member 149 is formed of a plastic material to integrally couple the rotor board 141, the coil 143, and the weight 145 to each other using an injection molding method. The support member 149 is coupled to an outer surface of the bearing 130.

Thus, a power supplied through the circuit board 150 is supplied to the coil 143 through the brush 170 and the rotor board 141 including the commutator 147. When the power is supplied to the coil, the rotor 140 rotates.

In the second embodiment, the second magnet 180 has internal and external diameters less than those of the first magnet 160.

The vibration motor according to the second embodiment includes the first magnet 160 and the second magnet 180. That is, the vibration motor may use two magnets to increase a magnetic flux.

In the vibration motor according to the second embodiment, the weight 145 includes a body part 145a and a first protrusion part 145b protruding from the body part 145a. A torque of the rotor 140 may increase by the first protrusion part 145b.

Thus, since a rotation force is significantly applied to the rotor 140, a rising time of the vibration motor may be reduced.

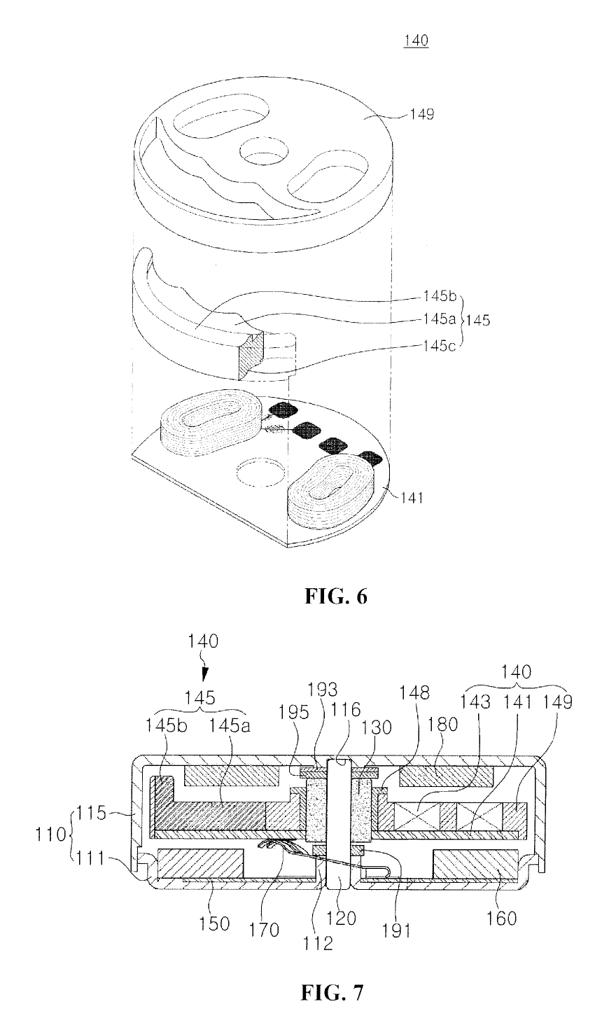

FIGS. 5 and 6 are views of a vibration motor according to a third embodiment.

In explanations of a vibration motor according to a third embodiment, only the parts different from those of the second embodiment will be described.

Referring to FIGS. 5 and 6, a vibration motor according to a third embodiment includes a weight 145 including a body part 145a, a first protrusion part 145b protruding upwardly from the body part 145a, and a second protrusion part 145c protruding downwardly from the body part 145a.

At least portion of the first protrusion part 145b may vertically overlap with that of the second protrusion part 145c.

Like the first protrusion part 145b, the second protrusion part 145c may be disposed at an external portion of the body part 145a spaced farthest from the support shaft 120.

Similar to that described in the second embodiment, the first and second protrusion parts 145b and 145c provide a greater vibration force to tile vibration motor.

The weight 145 is in contact with top and lateral surfaces of the rotor board 141. At least portion of the second protrusion part 145c may be flush with the rotor board 141.

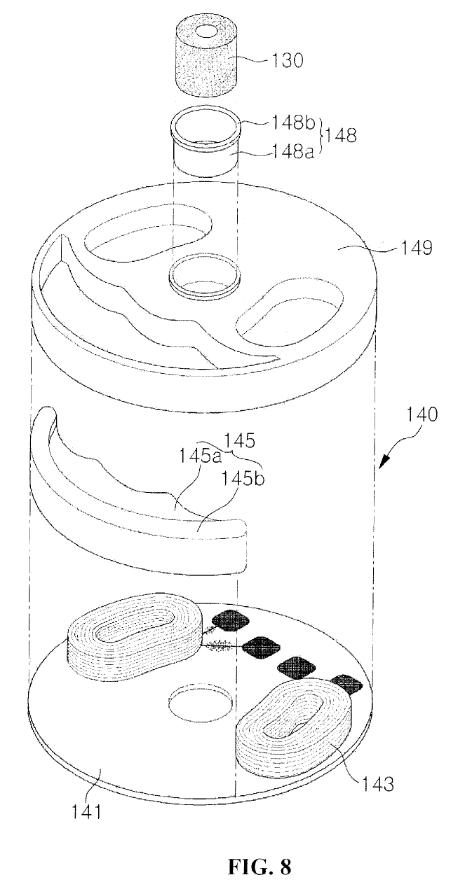

FIGS. 7 and 8 are views of a vibration motor according to a fourth embodiment.

In explanations of a vibration motor according to a fourth embodiment, only the parts different from those of the second embodiment will be described.

Referring to FIGS. 7 and 8, a bearing 130 is rotatably coupled to a support shaft 120. An eccentric rotor 140 for generating vibration while the eccentric rotor 140 is coupled to the bearing 130 to integrally rotate together with the bearing 130 is coupled to the bearing 130.

A support member 149 of the rotor 140 may be formed of a plastic material, and the bearing 130 may include a metal bearing. When the support member 140 is directly coupled to the bearing 130 the coupling of the support member 149 and the bearing 130 is weal. Thus, the support member 149 may be separated from the bearing 130.

Accordingly, in the vibration motor according to the fourth embodiment, a bearing yoke 148 formed of a metallic material is disposed between the support member 149 of the rotor 140 and the bearing 130.

When all of the bearing 130 and the bearing yoke 148 are formed of metallic materials the support member 149 may be strongly coupled to the bearing 130.

The bearing yoke 148 includes a coupling tube 148a contacting with the bearing 130 and a hook part 148b extending in an outward radius direction from an upper end of the coupling tube 148a.

A lower end of the coupling tube 148a is in contact with and supported to a rotor board 141. An outer surface of the coupling tube 148a is coupled to the support member 149, and the bearing 130 is forcedly inserted into an inner surface of the coupling tube 148a. The coupling tube 148a may be forcedly inserted into the support member 149 or integrally coupled to the support member 149 using an injection molding method.

The hook part 148b is in contact with and supported to a top surface of the support member 149.

Since the coupling tube 148a has an external diameter greater than that of the bearing 130, their coupling area may become wider. Thus the coupling tube 148a may be further strongly coupled to the support member 149.

Also, the bearing yoke 148 may be further strongly coupled to the support member 149 by the hook part 148b.

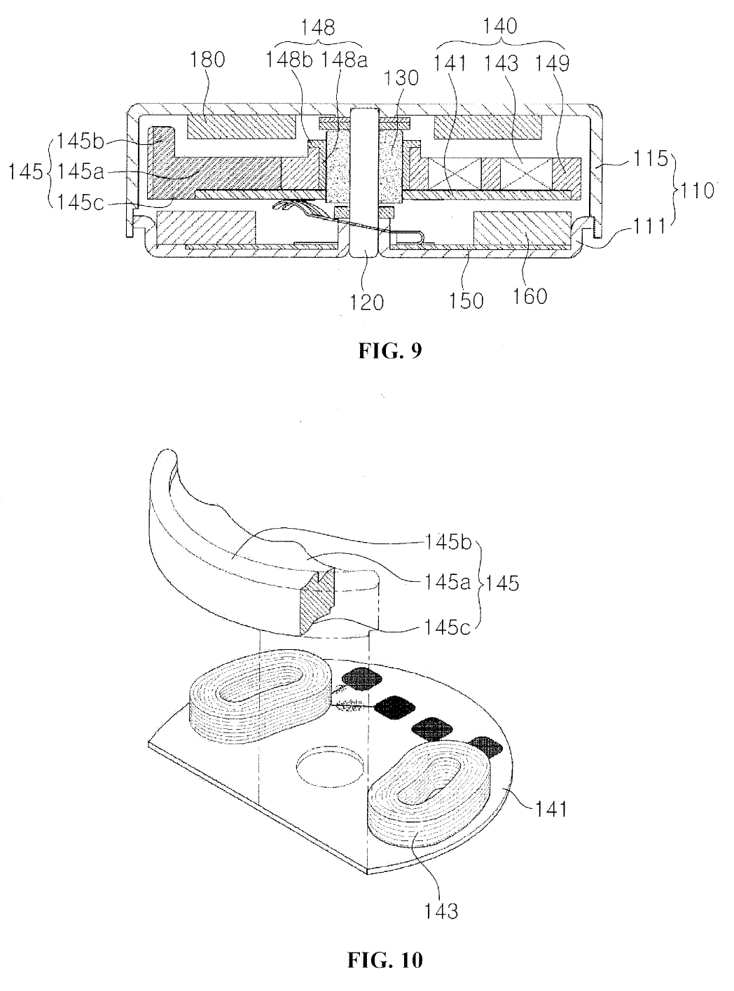

FIGS. 9 and 10 are views of a vibration motor according to a fifth embodiment.

In explanations of a vibration motor according to a fifth embodiment, only the parts different from those of the third embodiment will be described.

Referring to FIGS. 9 and 10, a bearing 130 is rotatably coupled to a support shaft 120. An eccentric rotor 140 for generating vibration while the eccentric rotor 140 is coupled to the bearing 130 to integrally rotate together with the bearing 130 is coupled to the bearing 130.

A support member 149 of the rotor 140 may be formed of a plastic material, and the bearing 130 may include a metal bearing. When the support member 140 is directly coupled to the bearing 130, the coupling of the support member 149 and the bearing 130 is weak. Thus, the Support member 149 may be separated from the bearing 130.

Accordingly, in the vibration motor according to the fifth embodiment, a bearing yoke 148 formed of a metallic material is disposed between the support member 149 of the rotor 140 and the bearing 130.

When all of the bearing 130 and the bearing yoke 148 are formed of metallic materials, the support member 149 may be strongly coupled to the bearing 130).

The bearing yoke 148 includes a coupling tube 148a contacting with the bearing 130 and a hooking part 148b extending in an outward radius direction from an upper end of the coupling tube 148a.

A lower end of the coupling tube 148a is in contact with and supported to a rotor board 141. An outer surface of the coupling tube 148a is coupled to the support member 149, and the bearing 130 is forcedly inserted into an inner surface of the coupling tube 148a. The coupling tube 148a may be forcedly inserted into the support member 149 or integrally coupled to the support member 149 using an injection molding method.

The hook part 148b is in contact with and supported to a top surface of the support member 149.

Since the coupling tube 148a has an external diameter greater than that of the bearing 130, their coupling area may become wider. Thus, the coupling tube 148a may be further strongly coupled to the support member 149.

Also, the bearing yoke 148 may be further strongly coupled to the support member 149 by the hook part 148b.

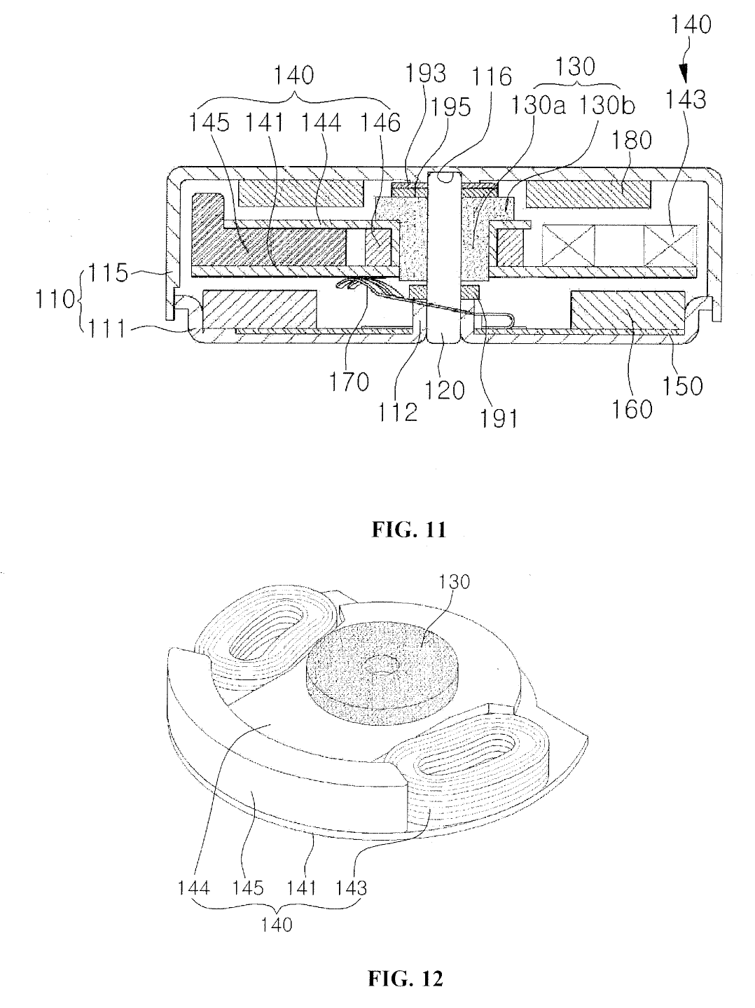

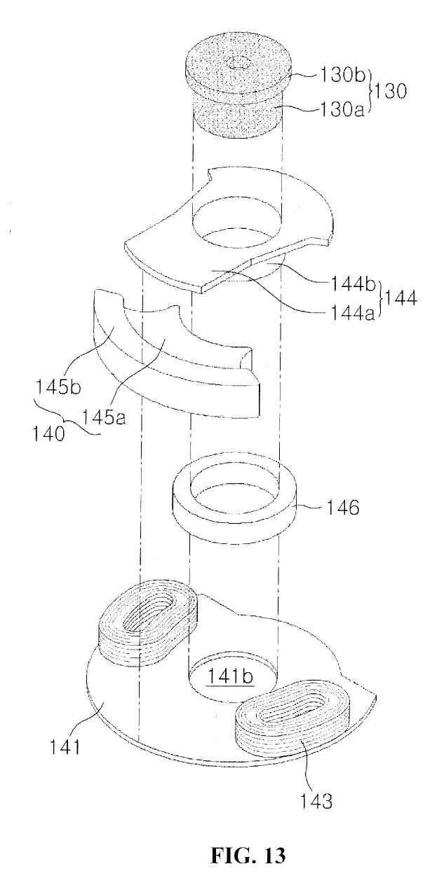

FIGS. 11, 12 and 13 are views of a vibration motor according to a sixth embodiment.

In explanations of a vibration motor according to a sixth embodiment, explanations duplicated with the first and fourth embodiments will be omitted.

Referring to FIGS. 11 to 13, a housing 110 including a bracket 111 and a case 115 is disposed. A support shaft 120 is disposed inside the housing 110.

The support shaft 120 is coupled and supported to a support tube 112 protruding from the bracket 111 and a groove 116 defined in the case 115.

A bearing 130 is rotatably disposed on the support shaft 120. An eccentric rotor 140 that integrally rotates together with the bearing 130 to generate vibration is coupled to the bearing 130.

A first washer 191 is disposed between the bearing 130 and the bracket 111 to reduce a friction force between the bearing 130 and the bracket 111. A second washer 193 is disposed between the bearing 130 and the case 115 to reduce a friction force between the bearing 130 and the case 115.

A third washer 195 is disposed between the second washer 193 and the bearing 130 to reduce a friction force between the second washer 193 and the bearing 130.

A circuit board 150 surrounding the support shaft 120 is fixed to the bracket 111. Also, a first magnet 160 surrounding the support shaft 120 and having a ring shape is disposed on the bracket 111. A second magnet 180 is disposed inside the case 115.

The rotor 140 is coupled to the bearing 130.

The bearing 130 includes a bearing body part 130a coupled to the support shaft 120 and a bearing protrusion part 130b protruding in an outward radius direction from an upper portion of the bearing body part 130a.

An outer surface or the bearing body part 130a is coupled to an inner surface of the rotor 140. A bottom surface of the bearing protrusion part 130b is coupled to a top surface of the rotor 140.

The bearing 130 has a thickness longer than that of the rotor 140 to increase a coupling area between the bearing 130 and the support shaft 120. Thus., the bearing 130 is exposed in a lateral direction from upper and lower portions of the rotor 140.

The rotor 140 includes a rotor board 141, a coil 143, a weight 145, a rotor yoke 144, and a support washer 146.

The rotor board 141 includes a commutator disposed on a bottom surface thereof and the coil 143 electrically connected to the rotor board 141 is disposed on a top surface of the rotor board 141.

The rotor board 141 has an approximately semicircular plate shape to surround the bearing 130. A through hole 141b is defined in a central portion of the rotor board 141. A brush 170 is disposed on the circuit board 150. The brush 170 elastically contacts with the commutator of the rotor board 141. The brush 170 electrically connects the circuit board 150 to the rotor board 141.

The coil 143 may be fixed to the rotor board 141 using an adhesive. The coil 143 is electrically connected to the rotor board 141.

The weight 145 is supported to the rotor board 141. The rotor 140 is eccentric by the weight 145 to generate a vibration force.

The weight 145 includes a body part 145a and a first protrusion part 145b protruding upwardly from the body part 145a. The first protrusion part 145b is disposed at an external portion of the body part 145a spaced farthest from the support shaft 120. At least a portion of the first protrusion part 145b may protrude until at least a, portion of the first protrusion part 145b is flush with the second magnet 180.

Thus, since the first protrusion part 145b is included, the weight 145 increases in weight. In addition, since the center of gravity of the weight 145 is spaced further away from that of the rotor 140, the vibration motor may have a greater vibration force.

Since the weight 145 and the coil 143 are disposed on the rotor board 141 in the sixth embodiment, a bottom surface of the weight 145 is flush with that of the coil 143.

The support washer 146 may be fixed to a top surface of the rotor board 141 using the adhesive. The support washer 146 may be fixed to the rotor yoke 144 using the adhesive. The support washer 146 may increase a coupling force between the rotor board 141 and the rotor yoke 141.

The rotor yoke 144 includes a coupling plate 144a and a coupling tube 144b.

The coupling plate 144a has one side coupled to the body part 145a of the weight 145 using a welding or laser spot welding and the other side coupled to the bearing protrusion part 130b of the bearing 130.

The coupling plate 144a magnetically separates the weight including a nonmagnetic body from the second magnet 180.

The coupling plate 144a does not contact with a top surface of the coil 143. Thus, the coil 143 may extend up to a height of a top surface of the coupling plate 144a. As a result, the number of windings of the coil 143 may increase to increase a vibration force of the rotor 140.

An outer surface of the coupling tube 144b is coupled to an inner surface of the support washer 146 using the adhesive. An inner surface of the coupling tube 144b is forcedly inserted into an outer surface of the bearing 130.

The rotor yoke 144 strongly couples the bearing 130 to the rotor 140.

Unlike the previously described embodiments., the vibration motor according to the sixth embodiment does not include the support member formed of the plastic material.

This, the coil 143 may be disposed at an outermost position of the rotor board 141 to increase the vibration force of the rotor 140 and reduce a rising time.

Therefore, a power supplied through the circuit board 150 is supplied to the coil 143 through the brush 170 and the rotor board 141 including the commutator 147. When the power is supplied to the coil, the rotor 140 rotates.

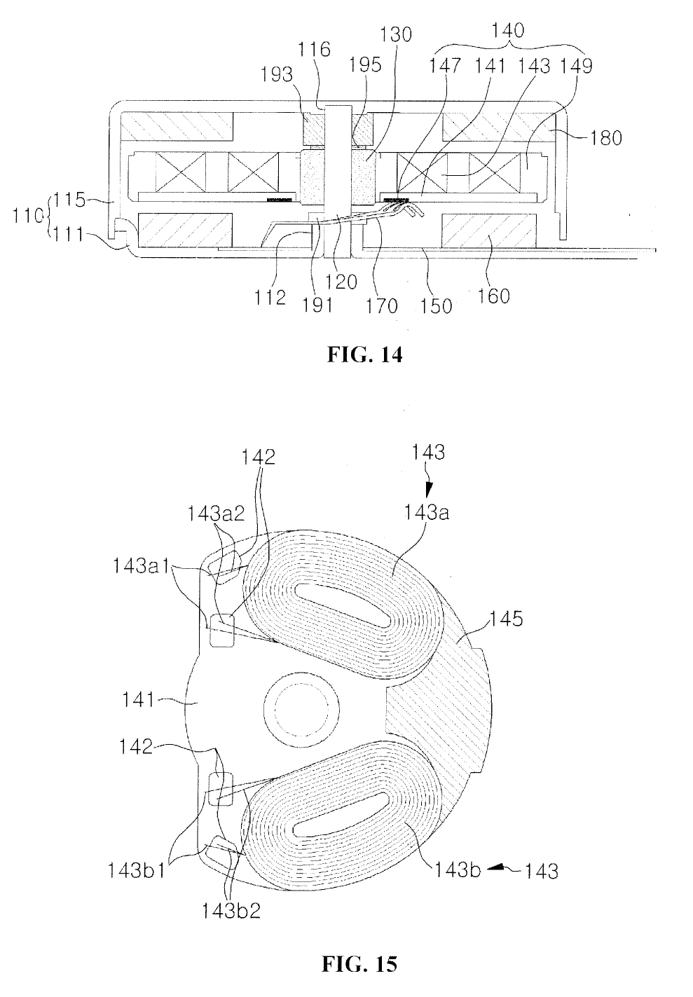

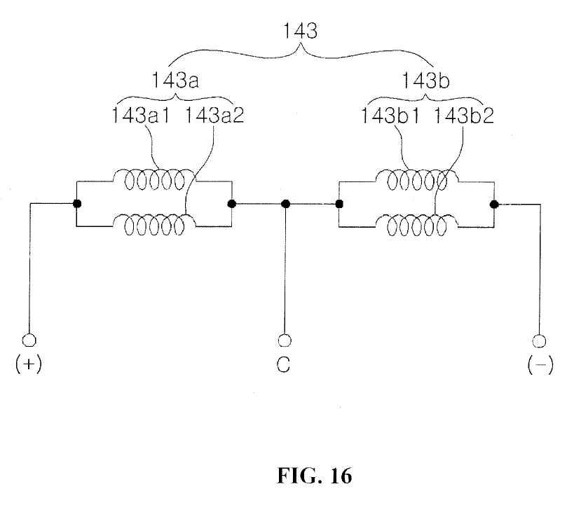

FIGS. 14 to 16 are views of a vibration motor according to a seventh embodiment.

In explanations of a vibration motor according to a seventh embodiments explanations duplicated with the first embodiment will be omitted.

Referring to FIGS. 14 to 16, a vibration motor according to a seventh embodiment includes a double wound coil 143.

The coil 143 includes a first coil 143a and a second coil 143b. The first and second coils 143a and 143b are doubly wound using two fine wires, respectively.

That is, a first fine wire 143a1 and a second fine wire 143a2 are doubly wound to form-y the first coil 143a. The first and second fine wires 143a1 and 143a2 are connected in parallel to each other through a pad 142 disposed on the rotor board 141.

Similarly, a first fine wire 143b1 and a second fine wire 143b2 are doubly wound to form the second coil 143b. The first and second fine wires 143b1 and 143b2 are connected in parallel to each other through the pad 142 disposed on the rotor board 141.

In the vibration motor, a torque acting on the rotor 140 has an effect on magnetic flux densities of the first and second magnets 160 and 180, the number of winding of the coil 143, and a current flowing into the coil 143.

When the first and second magnets 160 and 180 are used, the rotor 140 may have a greater torque as compared with the case where only the first magnet 160 is used. Also, when the number of winding of the coil 143 and a density of the current increase, the rotor 140 may have a greater torque.

However, when the number of winding of the coil 143 increases, a resistance of the coil 143 increases to reduce the density of the current flowing into the coil 143.

Thus, the vibration motor according to the seventh embodiment uses a fine wire having a small diameter to increase the number of winding of the coil 143. In addition, the fine wire is doubly wound, and also, the double wound wires are connected in parallel to each other to reduce the resistance increasing by using the fine wire.

Since the fine wires are connected in parallel to each other, the resistance is reduced by half. In addition, since the number of winding of the coil 143 increases, the rotor 140 may have the greater torque.

For example, the fine wire used for the coil 143 may have a diameter less than about 0.035 mm. In the coil 143, the fine wire is doubly wound, and the double wound wires are connected in parallel to each other.

Therefore, in the vibration motor according to the seventh embodiment, since the greater torque is applied to the rotor 140, a rising time may be reduced. The technical scope according to the seventh embodiment may be applicable to the above-described other embodiments.

As described above, the vibration motor according to the embodiments may include the first and second magnets 160 and 180 to increase the vibration force and reduce the rising time of the vibration motor.

Any reference in this specification to “one embodiment,” “an embodiment,” “exemplary embodiment,” etc., means that a particular feature, structure, or characteristic described in connection with the embodiment is included in at least one embodiment of the disclosure. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with others of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements alternative uses will also be apparent to those skilled in the art.

What is claimed is:

1. A vibration motor comprising:
a housing comprising a bracket and a case coupled to the bracket;
a support shaft supported and fixed to the housing;
a rotor rotatably disposed on the support shaft:
a first stator on the bracket and a second stator on the case; and
a power supply supplying a power to the rotor to rotate the rotor.

2. The vibration motor according to claim 1, wherein the rotor comprises a coil; wherein the power supply comprises a circuit board disposed on the bracket and a brush electrically connecting the circuit board to the rotor; and wherein the first stator and the second stator respectively comprise a first magnet and a second magnet.

3. The vibration motor according to claim 1, further comprising a bearing rotatably coupled to the support shaft.
wherein the rotor is coupled to the bearing.

4. The vibration motor according to claim 3, further comprising:
a first washer between the bearing and the bracket;
a second washer between the bearing and the case; and
a third washer between the second washer and the bearing.

5. The vibration motor according to claim 4, wherein the third washer has an external diameter less than that of the bearing.

6. The vibration motor according to claim 3, further comprising a bearing yoke coupled to the rotor and forcedly inserted into the bearing.

7. The vibration motor according to claim 6, wherein the bearing yoke comprises a coupling tube contacting with the bearing and a hook part extending from an upper end of the coupling tube in an outward radius direction, and wherein the hook part is disposed above the rotor.

8. The vibration motor according to claim 3, wherein the rotor comprises:
a rotor board comprising a commutator;
a coil fixed to the rotor board and electrically connected to the rotor board,
a weight coupled to the rotor board, and
a rotor yoke coupled to the rotor board and the weight, the rotor yoke forcedly inserted into the bearing.

9. The vibration motor according to claim 8, wherein the coil directly adheres to the rotor board.

10. The vibration motor according to claim 8, wherein the bearing comprises a bearing body part coupled to the support shaft and a bearing protrusion part protruding from an upper portion of the bearing body part in an outward radius direction, wherein the bearing protrusion part is coupled to a top surface of the rotor yoke.

11. The vibration motor according to claim 1, wherein the second stator has an internal diameter equal to or less than that of the first stator and an external diameter equal to or greater than that of the first stator.

12. The vibration motor according to claim 11, wherein a gap G1 between the first stator and the rotor and a gap G2 between the second stator and the rotor have a ratio of from about 1:0.2 to about 1:1.

13. The vibration motor according to claim 11, wherein a thickness t1 of the first stator and a thickness t2 of the second stator have a ratio of from about 1:0.3 to about 1:1.

14. The vibration motor according to claim 1, wherein the rotor comprises:
a rotor board comprising a commutator,
a coil electrically connected to the rotor board:
a weight on the rotor board, and
a support member integrally coupling the rotor board, the coil, and the weight to each other.

15. The vibration motor according to claim 14, wherein the weight comprises a body part and a first protrusion part protruding from the body part toward the case.

16. The vibration motor according to claim 15, wherein at least a portion of the first protrusion part is flush with the second stator.

17. The vibration motor according to claim 15, wherein the weight further comprises a second protrusion part protruding from the body part toward the bracket.

18. The vibration motor according to claim 17, wherein at least a portion of the second protrusion part is flush with the rotor board.

19. The vibration motor according to claim 1, wherein the rotor comprises a first coil and a second coil, wherein the first coil and the second coil are doubly wound using a first fine wire and a second fine wire, respectively.

20. The vibration motor according to claim 19, wherein the first fine wire and the second fine wire are connected in parallel to each other.
